(19) United States
(12) Patent Application Publication
(10) Pub. No.: US 2013/0036005 A1
(43) Pub. Date: Feb. 7, 2013

(54) SYSTEM AND METHOD FOR PROVIDING A WEB BROWSER HOMEPAGE AS A MEANS FOR INCREASING TARGET GROUP WEBSITE TRAFFIC AND GENERATING CONSUMER INCOME

(71) Applicant: Hajo Hendrik Rappe, Neuss (DE)

(72) Inventor: Hajo Hendrik Rappe, Neuss (DE)

(21) Appl. No.: 13/511,950

(22) PCT Filed: Nov. 25, 2009
(86) PCT No.: PCT/IB2009/007708

§ 371 Date: Oct. 15, 2012

(51) Int. Cl. G06F 17/00; G06Q 30/02

(52) U.S. Cl. 705/14.48; 715/234

(57) ABSTRACT

A system and method of displaying a website as the homepage for a computer web browser. The method includes the steps of identifying the computer, selecting a web page to be displayed as the browser's homepage (“Selected Web Page”), displaying the Selected

Web Page in the web browser without requiring any further activation by or action the user, determining whether to charge an operator of the Selected Web Page a fee for the display of the Selected Web Page as the web browser's homepage, and determining whether to grant a reward to the user of the computer for viewing the Selected Web Page. The method of choosing the Selected Web Page includes comparing the computer user's website selection criteria with the target consumer criteria of multiple web pages.

### BACKGROUND

The present invention is directed towards a system and method for providing a web browser homepage as a means for increasing target group website traffic and generating consumer income.

In today's global and electronic marketplace, many individuals and entities advertise their goods and services via Internet websites. Websites are also used by individuals and entities to convey information in non-commercial ways, such as blogs and personal websites. All such owners and operators of websites utilized for commercial and/or non-commercial purposes are collectively hereinafter referred to as “vendors.” In general, the value of a vendor's website is largely dependent on the amount of traffic, or visits, that such website receives. Asides from general search engine optimization techniques, many vendors have attempted to increase traffic to their websites by purchasing banners or advertisements based on search engine keywords, such as Google AdWords®. In those advertisement methods, the vendor typically pays the publisher of the advertisement, such as Google®, for ad-impressions or on a per-click basis (clicks made by the users). Costs per click can be quite expensive depending on the popularity of the requested keyword. Also, independent of the payment method, ads and banners are effective in generating website traffic only if users actually click on the advertisement to be directed to the vendor's website. Thus, the third party publisher's website (such as Google®) serves as an interface between the user and the vendor's website. Such publishers are able to accrue substantial revenue each day from their advertising vendors in per-click fees based on typical consumer web-surfing activity. Even though consumer action (clicking on the advertisements) is required most times for the publishers to accrue such revenue, consumers are not rewarded in any way for their clicks on the advertisements. Furthermore, because some types of Internet advertising paid for by vendors may not be targeted to a specific audience, such vendors may pay for ad-impressions to consumers who have no interest in visiting the respective vendor's websites.

It is, therefore, desirable to utilize a system for increasing targeted traffic to vendor websites with minimal consumer action required and rewarding consumers for their participation in increasing such website traffic.

### SUMMARY OF THE INVENTION

A method of causing a website to be displayed as the homepage for at least one computer's web browser including the steps of identifying at least one computer having a web browser in which a homepage URL (“Transition URL”) has been designated for the web browser, selecting a web page having a URL that is differs from the Transition URL to be displayed as the web browser's homepage (“Selected Web Page”), communicating instructions capable of causing the Selected Web Page to be displayed in the web browser of the computer when a homepage activator associated with the web browser is activated, and determining whether to charge an operator of the Selected Web Page a fee for communicating the instructions capable of causing the Selected Web Page to be displayed as the web browser's homepage. The method further includes the step of determining whether to grant a user associated with the computer a reward for the display of the Selected Web Page as the web browser's homepage.

The homepage activator is activated by engaging a homepage button in the web browser or opening the web browser. The instructions are capable of causing the Selected Web Page to be the first web page displayed in the web browser when the web browser's homepage activator is activated, without requiring any further activation or action by the user. The identifying step includes the step of identifying the computer based on the

Transition URL and/or a web browser cookie. The selecting step includes the step of analyzing web page selection criteria that is communicated from a user associated with the computer, wherein the web page selection criteria may consist of the user's age, sex, geographic location, language, income level, career, and topics of interest. The selecting step further includes the step of analyzing target consumer criteria for a plurality of web pages, wherein the target consumer criteria may consist of target consumer age, sex, geographic location, language, income level, career, and topics of interest. The target consumer criteria for each web page in the plurality of web pages is communicated from at least one person that has reviewed the content of the web page.

The method also includes the step of determining whether the web browser's homepage activator has been activated for the first time within a predetermined time interval. The selecting step may include the steps of determining whether any web page operator has chosen to have its web page be the Selected Web Page the first time the web browser's homepage activator is activated within the first predetermined time interval, and selecting a particular web page to be the Selected Web Page if it is determined that the web browser's homepage activator has been activated for the first time within the first predetermined time interval and the operator of that particular web page has chosen to have its web page be the Selected Web Page the first time the web browser's homepage activator is activated within the first predetermined time interval.

The step of determining whether to grant the user associated with the computer a reward for the display of the Selected Web Page includes the steps of determining whether a second predetermined time interval has lapsed between consecutive activations of the web browser's homepage activator, and if the second predetermined time interval has not lapsed, determining that no reward will be granted to the user for the display of the Selected Web Page in the web browser of the computer. The step of determining whether to grant the user associated with the computer a reward for the display of the Selected Web Page may also include the steps of determining whether a third predetermined time interval has lapsed between communicating the instructions capable of causing the Selected Web Page to be displayed in the web browser of the computer and the user's initiation of a web page termination event, the web page termination event being selected from the group consisting of a user's closing the Selected Web Page, leaving of the Selected Web Page to go to a different web page, closing of the web browser, and reactivation of the home page activator, and if the third predetermined time period has not lapsed, determining that no reward will be granted to the user for the display of the Selected Web Page in the web browser of the computer. The step of determining whether to grant the user associated with the computer a reward for the display of the Selected Web Page includes the steps of determining whether the web browser's homepage activator has been activated more than a predetermined number of times within the first predetermined time interval, and if the web browser's homepage activator has been activated more than a predetermined number of times within the first predetermined time interval, determining that the no reward will be granted to the user for display of the Selected Web Page in the web browser of the computer. The method further includes the step of granting a reward to the user associated with the computer for the display of the Selected Web Page in the web browser of the computer, and the reward may have a value selected from the group consisting of a monetary value and a credit value.

The method further includes the step of randomly selecting the Selected Web Page from a plurality of web pages if it is determined that the user associated with the computer will not be rewarded for display of the Selected Web Page in the web browser. The method may also include the step of selecting a predetermined web page chosen by the user as the Selected Web Page if it is determined that the user associated with the computer will not be rewarded for display of the Selected Web Page in the web browser of the computer. The selecting step further includes the steps of comparing the user's web page selection criteria with the target consumer criteria for the plurality of web pages and filtering from a set of the plurality of web pages any web pages with target consumer criteria that do not align with any aspect of the user's web page selection criteria. The selecting step further includes the steps of filtering from the set of the plurality of web pages any web pages that have already been displayed in the computer's web browser within a predetermined time interval and randomly selecting the Selected Web Page from the plurality of web pages remaining in the set after the filtering step. The selecting step may further include the step of selecting a predetermined web page chosen by the user as the Selected Web Page if it is determined that there are no web pages remaining in the set after the filtering step.

The method includes the steps of charging the operator of the Selected Web Page a fee for communicating the instructions capable of causing the Selected Web Page to be displayed as the homepage of the web browser and deducting from a prepaid account the fee charged to the operator of the Selected Web Page. An operator of a web page may establish an advertising budget that limits an amount of fees that may be charged to the operator for its web page being selected as the Selected Web Page. The method may include the steps of determining whether the advertising budget associated with a web page has been met or exceeded, and if the advertising budget has been met or exceeded, preventing that web page from being the Selected Web Page.

The method may include the step of communicating instructions capable of causing the display of an information bar in the web browser of the computer when the Selected Web Page is displayed in the web browser, wherein the information bar provides information such as a hyperlink to a system website, the user's account balance, and information regarding whether the user was designated to receive the reward for display of the Selected Web Page. The method may include the step of granting a second user of a second computer a referral reward for the first user displaying the Selected Web Page in the web browser of the first computer. The method may also include the step of granting to charitable cause a portion of any fee charged to the operator of the Selected Web Page for the display of the Selected Web Page in the web browser of the computer.

The step of communicating instructions capable of causing the Selected Web Page to be displayed in the web browser may include the step of redirecting the Transition URL to the URL of the Selected Web Page when the homepage activator associated with the web browser is activated or framing the Selected Web Page in a web page associated with the Transition URL when the homepage activator associated with the web browser is activated. The framing step includes the step of framing the Selected Web Page using a framing technique selected from the group consisting of a frame, iframe, and division-tag (DIV).

The computer may be a digital computing device such as a personal computer, personal digital assistant (PDA), or mobile phone.

An additional method of causing a website to be displayed as the homepage for at least one computer's web browser is provided, including the steps of identifying at least one computer having a web browser in which a homepage URL (“Transition URL”) has been designated for the web browser, selecting a web page having a URL that is differs from the Transition URL to be displayed as the web browser's homepage (“Selected Web Page”), and communicating instructions capable of causing the Selected Web Page to be displayed in the web browser of the computer, wherein selecting step includes the steps of analyzing web page selection criteria input by a user associated with the computer, the web page selection criteria being selected from the group consisting of the user's age, sex, geographic location, language, income level, career, and topics of interest, and analyzing target consumer criteria for a plurality of web pages, wherein the target consumer criteria is selected from the group consisting of target consumer age, sex, geographic location, language, income level, career, and topics of interest. When the web browser's homepage activator is activated, the first web page displayed in the web browser is the Selected Web Page without requiring any further activation or action by the user.

A computer system is provided that includes one or more processors, one or more memory units storing instructions operable with the one or more processors, the instructions being executed for identifying at least one computer having a web browser in which a homepage URL (“Transition URL”) has been designated for the web browser, selecting a web page having a URL that differs from the Transition URL to be displayed as the web browser's homepage (“Selected Web Page”), and communicating instructions capable of causing the Selected Web Page to be displayed in the web browser of the computer. The selecting step includes the steps of analyzing web page selection criteria input by the user associated with the computer, the web page selection criteria being selected from the group consisting of the user's age, sex, geographic location, language, income level, career, and topics of interest, and analyzing target consumer criteria for a plurality of web pages, wherein the target consumer criteria is selected from the group consisting of target consumer age, sex, geographic location, language, income level, career, and topics of interest. When the web browser's homepage activator is activated, the first web page displayed in the web browser is the Selected Web Page without requiring any further activation or action by the user.

An additional computer system is provided including one or more processors, one or more memory units storing instructions operable with the one or more processors, the instructions being executed for identifying at least one computer having a web browser in which a homepage URL (“Transition URL”) has been designated for the web browser, selecting a web page having a URL that differs from the Transition URL to be displayed as the web browser's homepage (“Selected Web Page”), communicating instructions capable of causing the Selected Web Page to be displayed in the web browser of the computer, determining whether to charge an operator of the Selected Web Page a fee for communicating the instructions capable of causing the Selected Web Page to be displayed as the web browser's homepage, and determining whether to grant a user associated with the computer a reward for the display of the Selected Web Page as the web browser's homepage.

### BRIEF DESCRIPTION OF THE FIGURES

The drawings referenced herein form a part of the specification. Features shown in the drawings are meant as illustrative of some, but not all, embodiments of the invention, unless otherwise explicitly indicated, and implications to the contrary are otherwise not to be made. Although in the drawings like reference numerals correspond to similar, though not necessarily identical, components and/or features, for the sake of brevity, reference numerals or features having a previously described function may not necessarily be described in connection with other drawings in which such components and/or features appear.

FIG. 1 is an exemplary block diagram of a system for providing a web browser homepage in accordance with an embodiment of the present invention;

FIGS. 2A-2C depict exemplary displays of the GUI of the homepage selection program relating to the client account registration process in accordance with an embodiment of the present invention;

FIG. 3 depicts an exemplary display of the GUI of the homepage selection program relating to the vendor advertisement campaign registration process in accordance with an embodiment of the present invention;

FIG. 4 is a flowchart of a method for providing a web browser homepage in accordance with an embodiment of the present invention;

FIG. 5 is a flowchart of method for processing payments made to the client and debited from the vendor in system for providing a web browser homepage in accordance with an embodiment of the present invention;

FIG. 6 depicts an exemplary GUI of a client's Internet browser displaying an information bar in accordance with an embodiment of the present invention; and

FIG. 7 is an exemplary block diagram of the architecture if a computing system that may be used in connection with the system of FIG. 1.

### DETAILED DESCRIPTION OF THE INVENTION

In the following detailed description of exemplary embodiments of the invention, reference is made to the accompanying drawings that form a part hereof, and in which are shown by way of illustration specific exemplary embodiments in which the invention may be practiced. While these embodiments are described in sufficient detail to enable those skilled in the art to practice the invention, it will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure. Specifically, other embodiments may be utilized, and logical, mechanical, electrical, electro-optical, software/firmware and other changes may be made without departing from the spirit or scope of the present invention. Accordingly, the following detailed description is not to be taken in a limiting sense, and the scope of the present invention is defined by the appended claims.

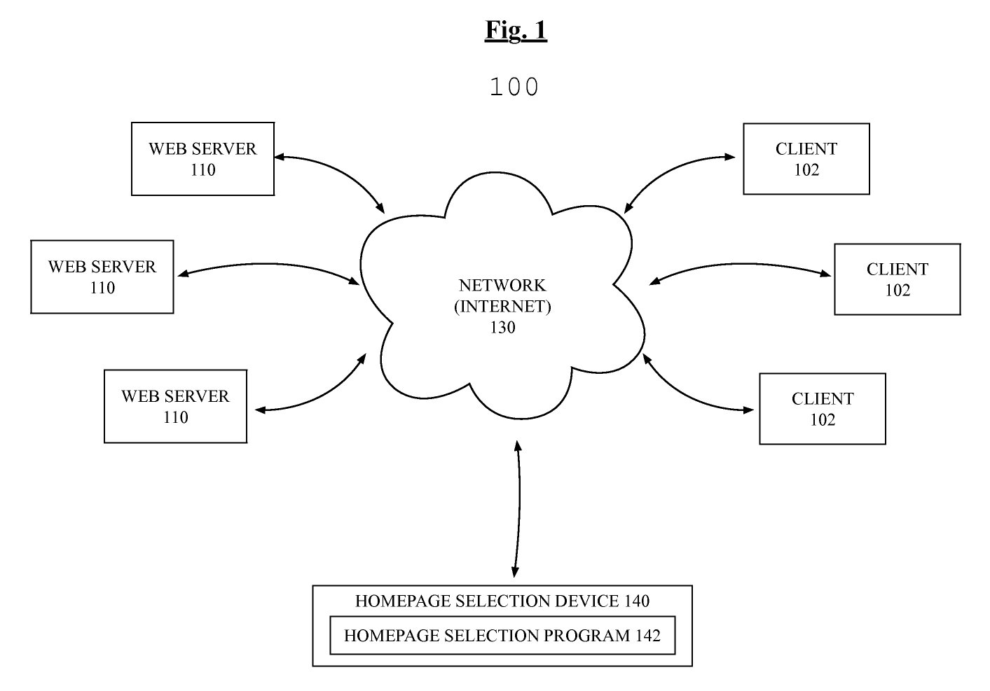

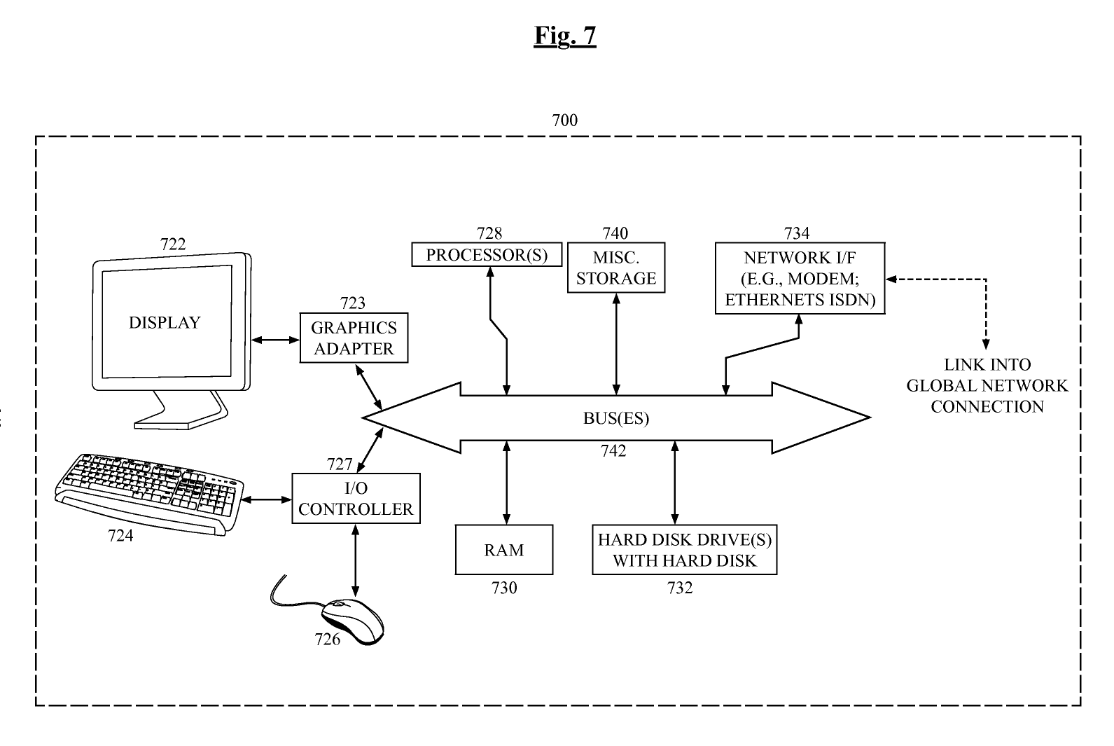

The present invention is directed towards a system and method for providing a web browser homepage as a means for increasing targeted website traffic and generating consumer income (also referred to herein as a “homepage selection system”). With reference now to the figures, FIG. 1 is a block diagram depicting an example of a homepage selection system 100 in accordance with an embodiment of the present invention. The system 100 includes multiple client computing systems 102 such as personal computers, personal digital assistants (PDAs), mobile phones, or other devices having input and display means and being capable of running an Internet browser (hereinafter referred to as client computers 102). Each client computer 102 may be a digital computer 700 of the type known in the art, an example of which is shown in FIG. 7. The computer 700 has a display 722, a key entry device 724, a pointing/clicking device 726, one or more processors 728, random access memory (RAM) 730, a graphics adapter 742, an input/output controller 727 (e.g., USB controller), and a communication or network interface 734 (e.g., modem; ethernet adapter). In addition, there commonly is a non-volatile storage device such as a hard disk drive 732. Other miscellaneous storage devices 740, such as a transportable storage media drive, a floppy disk drive, CD-ROM drive, zip drive, bernoulli drive or other magnetic, optical or other storage media, may be included. The various components interface and exchange data and commands through one or more busses 742. The computer 700 receives information via the input/output controller 727 by, for example, entry through the key entry device 724, pointing/clicking device 726, the network interface 734 or another input device or input port. The computer 700 may be any of the types well known in the art, such as a mainframe computer, minicomputer, or microcomputer and may serve as a network server computer, remote network computer or a client computer. The computer 700 may even be configured as a workstation, personal computer, network server, or a reduced feature network terminal device. While it is noted that Microsoft's Internet Explorer® is a commonly used Internet browser, it should be understood that the client computers 102 of the present invention may utilize any type of Internet browser that supports a browser homepage and enables users to access and search the Internet, such as Mozilla, Firefox, Chrome, Safari, Opera, SeaMonkey, Camino, and the like. All such browsers are well within the scope of this invention.

Referring again to FIG. 1, the homepage selection system 100 also includes a homepage selection device 140 on which a homepage selection computer program 142 is operated. The homepage selection device 140 may comprise one or more known computer systems, such as the example shown in FIG. 7, as described above. The homepage selection device 140 determines what website is displayed as the homepage of the Internet browser of each client computer 102, as explained in more detail below. The sources of such selected homepages may be various web servers 110 hosting vendor websites.

The homepage selection system 100 of the present invention utilizes a network 130 to provide communication links between various devices and computers connected together within the system 100, such as communication links between the client computers 102, the homepage selection device 140, and the web servers 110. The network 130 may include connections such as wire connections, wireless communication links, or fiber optic cables. As described herein, the network 130 may be the Internet, which represents a worldwide collection of networks and gateways that use the TCP/IP suite of protocols to communicate with one another. The homepage selection system 100 of the present invention may also be implemented as a number of different types of networks, such as an intranet, a local area network (LAN), or a wide area network (WAN). FIG. 1 is intended as an example, and not as an architectural limitation for the present invention.

The homepage selection system and method of the present invention will be described herein from the perspectives of consumers who are browsing the Internet from their respective client computers 102 (hereinafter referred to as “clients”) and owners and operators of websites stored on the web servers 110 that are utilized for commercial and/or non-commercial purposes (hereinafter referred to as “vendors”).

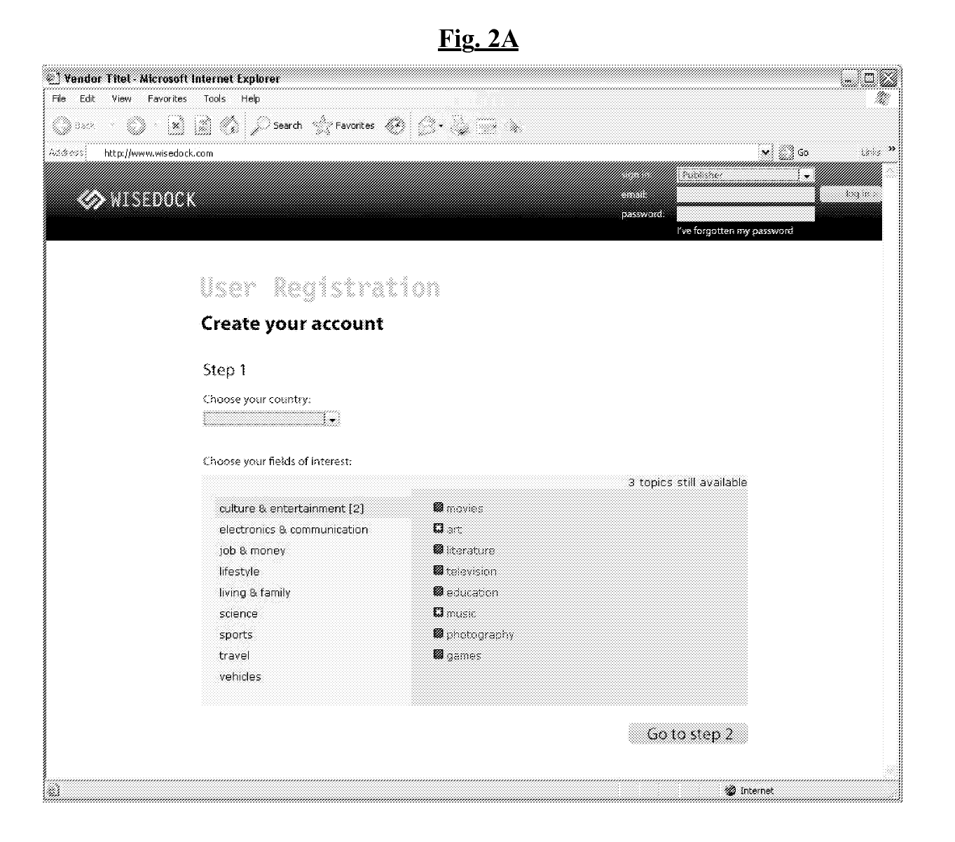

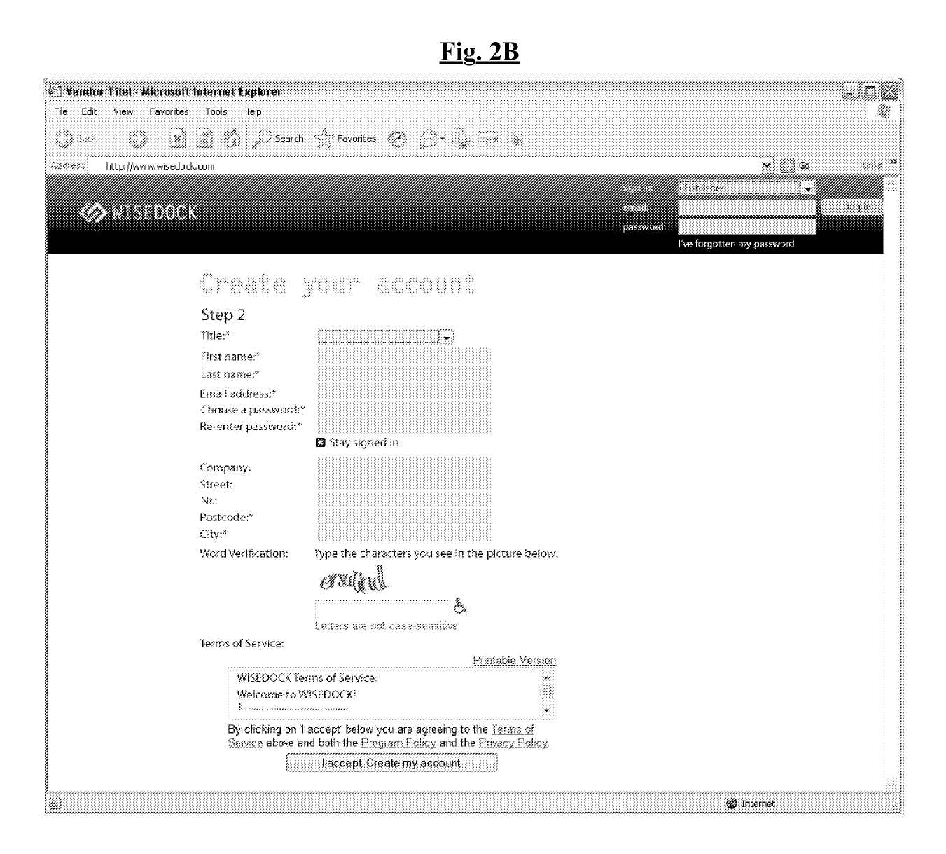

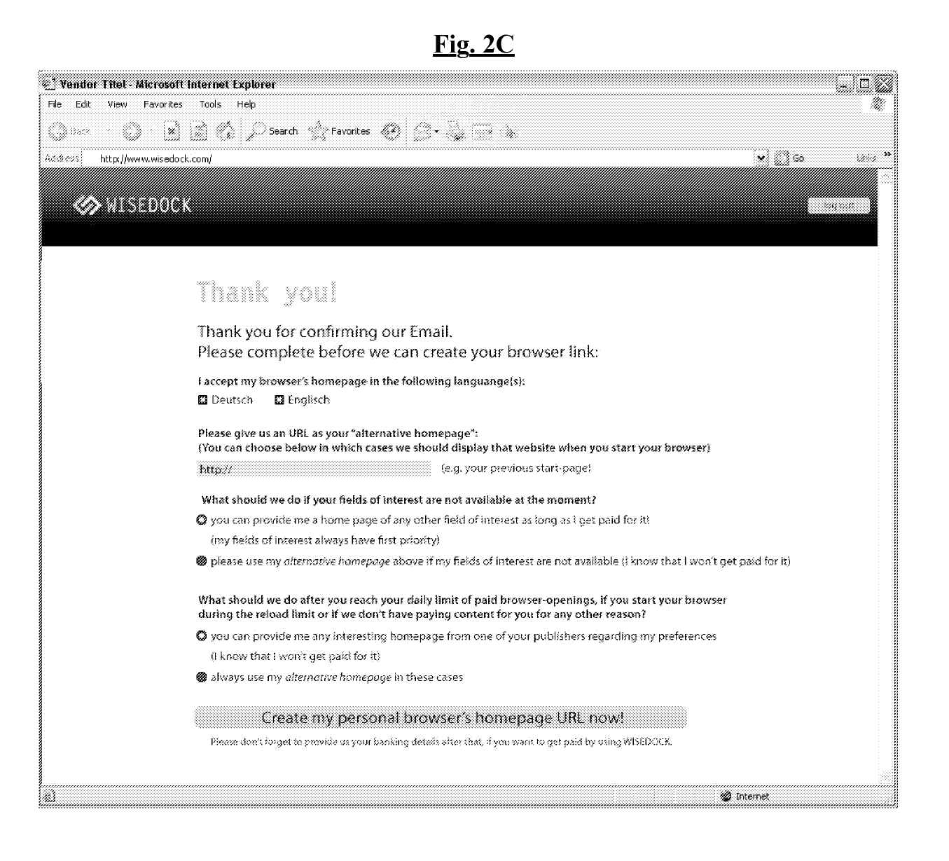

As shown in FIGS. 2A-2B, each client may initiate participation in the homepage selection system 100 of the present invention by accessing a website provided by the homepage selection program 142 (hereinafter referred to as the “System Website”) and creating an account. Such account registration process may include enabling the client to select the country or other geographic region in which he or she lives or chooses to be associated. The client may also select and rank certain topics for which the client may desire to access related websites. As shown in FIG. 2A, such topics may include: Lifestyle; Living/Family; Travel; Culture & Entertainment; Sports; Job & Money; Electronics & Communication; Science; and Vehicles. In one embodiment, the client may be given the option of ranking his or her topics of interest, for example, Lifestyle as Topic #1 (meaning highest level of interest) and Science as Topic #2 (meaning second highest level of interest). It should be understood that the present invention is not limited to any particular type or quantity of categories or other criteria that may be offered to the client for selection.

As shown in FIG. 2B, the client may be asked to submit certain biographical and contact information, such as full name, address, and email address, and create a password for his or her account. Either as part of the account registration process or thereafter, the System Website may further request the client to input the URL of a desired alternative homepage (the “Alternate Homepage”), as shown in FIG. 2C, and information relating to the client's bank account or other means for receiving electronic transfer of currency or credits, such as PayPal®, all of which is explained in more detail below.

Upon completion of the account registration process, the System Website may provide to the client, such as in an email, a designated URL that is to be inserted by the client into the Internet browser settings at his or her client computer 102 as the default homepage for the device's 102 Internet browser. Such designated URL may include an identifying indicia that is specific to that registered client, e.g., http://www.wisedock.com/?id=123abc (hereinafter referred to as the “Transition Homepage”).

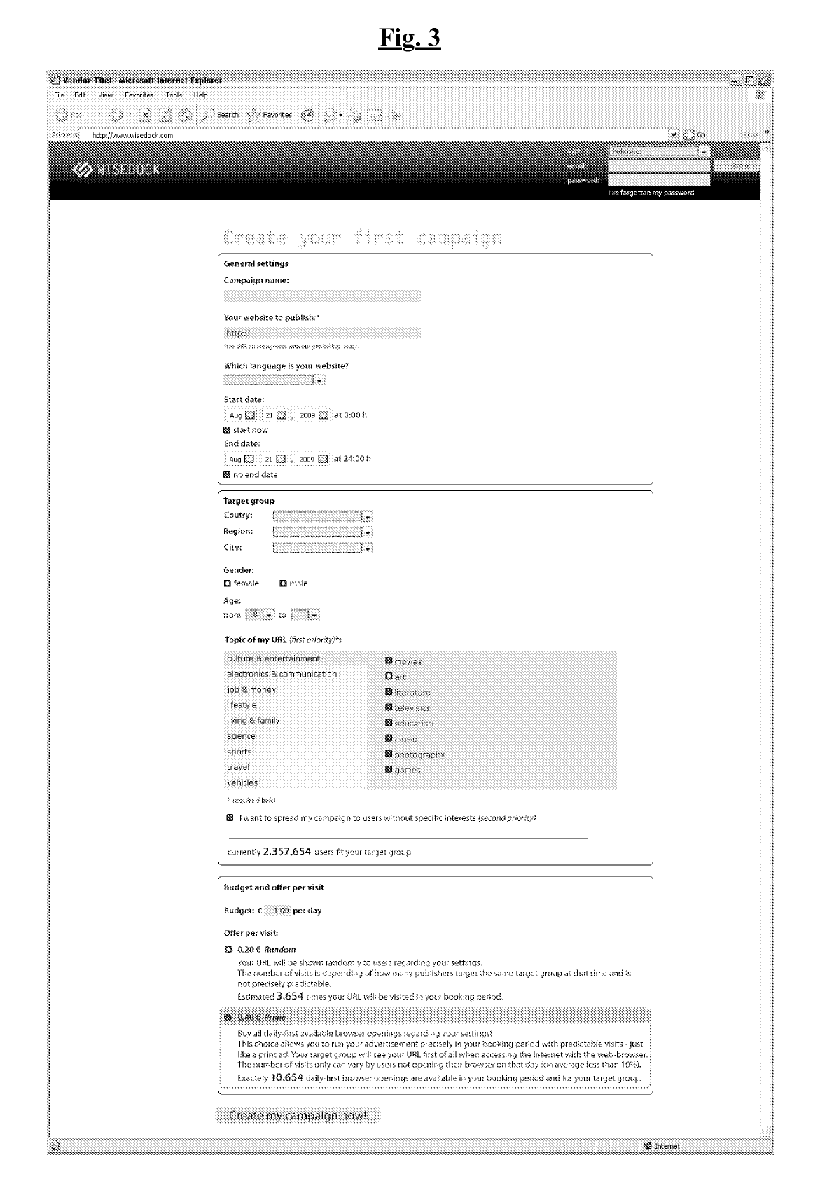

As shown in FIG. 3, each vendor may likewise initiate participation in the homepage selection system 100 of the present invention by accessing the System Website via the Internet 130 to create a vendor account by inputting general information such as the vendor's name, address, and email address, and designating an account password. The System Website then guides the registered vendor in creating one or more advertising campaigns for one or more of the vendor's websites. For example, the System Website may request information relating to the name of each campaign, the URL of the vendor's website, the language of the website, and the start and ending dates of the advertisement campaigns. The vendor may further input information relating to its target consumer audience, such as certain geographic regions, gender, age ranges, professions, and consumer topics of interest. In one embodiment, the list of topics of interest provided to the vendor during creation of the campaign are the same as the topics of interest that are provided to clients during their account registration, as described above with respect to FIG. 2A. Similar to the client account preferences, the vendor may be given the option of selecting and/or ranking the consumer topics of interest or other criteria based on the type of consumer(s) the vendor is trying to reach with its website.

As an additional part of the vendor's creation of an advertising campaign, the System Website may prompt the vendor to identify a budget for the campaign, such as a daily or weekly maximum that will be paid by the vendor to the system 100 administrator for display of vendor's website as the homepage on client computers 102. The System Website may also provide the vendor with the option of choosing different levels of advertising campaigns. As shown in FIG. 3, such options may include a “Random Option” and “Prime Option,” as explained in more detail below. The vendor's cost per client homepage display may depend on how broad or narrow is the selected target group of clients, as well as supply and demand based on the number of registered vendors wanting their websites displayed as client homepages in the same target group (e.g., age, location, topic of interest, etc.). The System Website prompts the vendor to pay for the selected advertising campaign via known methods such as credit card, electronic funds transfer, PayPal® and the like. The vendor's virtual account within the System Website is then credited with such payment.

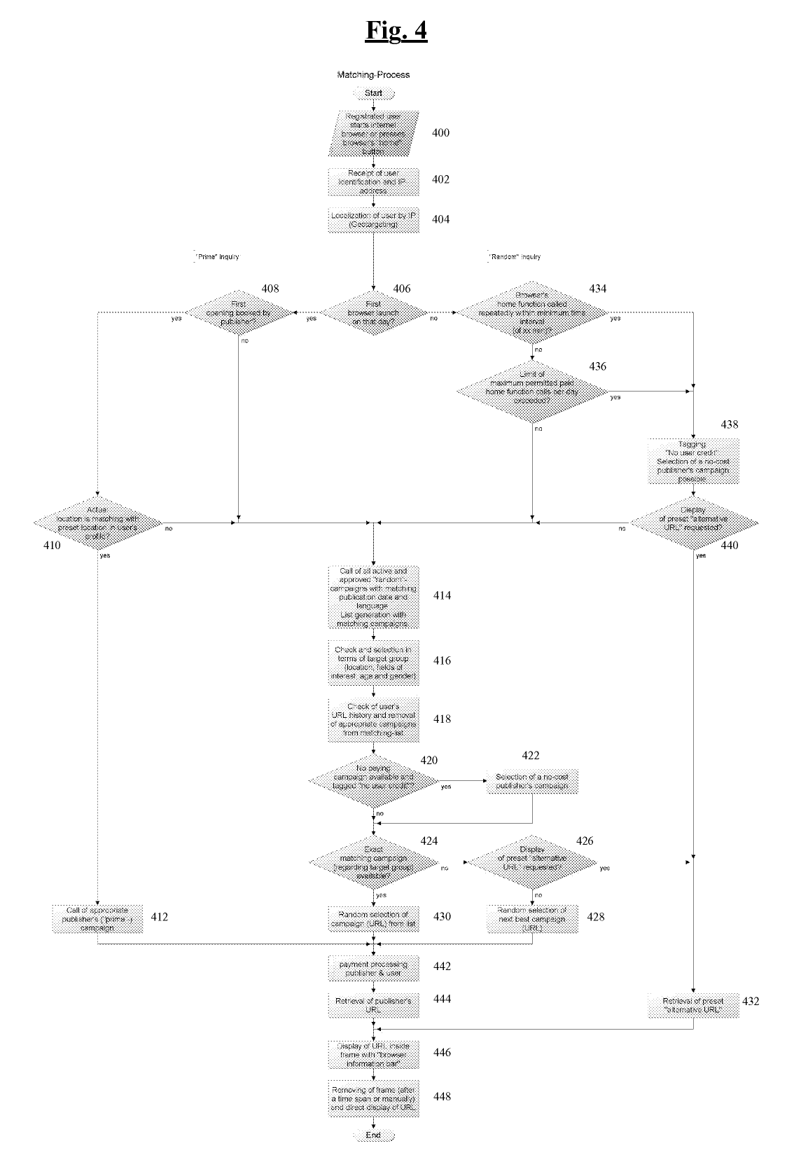

With reference now to FIG. 4, when a registered client activates its homepage by launching the Internet browser or clicking on the “Home” button within the Internet browser on his or her client computer 102 (step 400), the client's computer 102 transmits to the homepage selection device 140 the client's user identification (based on the URL of the client's Transition Homepage that is specific to the client computer 102 and/or a browser cookie) and the internet protocol (IP) address of the client computer 102 (step 402). The homepage selection program 142 determines the physical locale of the client based on such IP address (step 404) and then determines whether it is that client's first browser launch within a predetermined interval of time, such as within that day (step 406).

If it is the client's first browser launch for that predetermined time interval, the homepage selection program 142 determines whether any registered vendor has purchased a Prime Option for its advertising campaign for that client for that current time interval, such as that day or week (step 408). The Prime Option ensures a vendor that its website will be the first one displayed as the homepage in a client's Internet browser within a predetermined time interval. For example, a retailer of televisions may pay to purchase the Prime Option for its website on the day it is advertising a big sale. If the retailer is a national chain, it may choose to purchase the Prime Option so that every client in the nation that is registered with the system 100 and has selected “electronics” as a topic of interest is directed to that vendor's website as the first homepage launching on the client's computer 102 for that day. In an alternative, if the retailer operates in a limited geographic location, it may want to purchase the Prime Option only for reaching clients that selected “electronics” as a topic of interest and live in a particular geographic area. The Prime Option campaigns offer a vendor predictability that its website will be viewed by the specified target group of registered clients during the selected time interval because the system 100 directs the client computers 102 to display the vendor's website as the browser homepage for the clients' first browser launch during that time interval. Accordingly, the system 100 administrator is able to allocate (or sell) only one Prime Option campaign per target client (because each client can have only one “first” homepage launching per predetermined time interval). Thus, the cost to the vendor per homepage launch for Prime Option campaigns may be more expensive than Random Option campaigns.

Referring again to FIG. 4, if a vendor has purchased the Prime Option for the current time interval for that client, the homepage selection program 142 determines whether the actual location of the client (based on the IP address) matches the location in the client's profile as provided by the client during the account registration process (step 410). If there is a match, the homepage selection program 142 identifies the vendor who has purchased the Prime Option for that interval of time (step 412) in preparation for either redirecting the client's browser from the Transition Homepage to the website of that vendor that resides on a web server 110 or framing that vendor's website within the Transition Homepage.

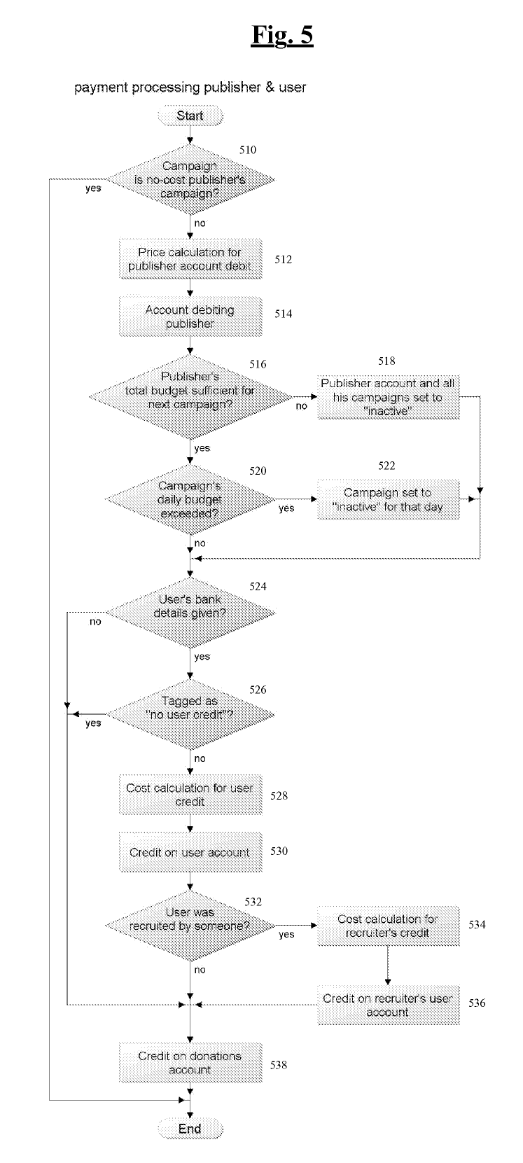

In one embodiment of the present invention, the homepage selection program 142 processes payment to the client for the display of the vendor's website as the browser's homepage and debits the vendor's account for having its website displayed to the client as client's homepage (step 442), as described in more detail below with regards to FIG. 5. While FIG. 4 illustrates such payment and debit processing as taking take place prior to the client computer's 102 browser framing of or redirection to the vendor's website, it should be understood that such payment processing may take place prior to, simultaneously with, or after the client computer's 102 browser frames or is redirected to the vendor's website.

Referring again to FIG. 4, after identifying a vendor campaign, the homepage selection program 142 retrieves the URL of that vendor's website on web server 110 (step 444) and either redirects the browser of the client computer 102 from the URL of the Transition Homepage to the URL of the vendor's website or frames the vendor's website within the Transition Homepage (step 446). Such redirection of the client's browser from the Transition Homepage to the vendor's website or framing of the vendor's website within the Transition Homepage is quick and seamless such that when the client launches or hits the “Home” button in the Internet browser on the computer 102, the first website that is displayed in the browser is that of the selected vendor's website. Thus, the System Website serves as a search engine running in the background that is invisible to the client. It is noted that even if the selected vendor's website is framed within the Transition Homepage, the vendor's website may be solely or substantially displayed in the web browser such that the only readily apparent evidence of the vendor website being framed is that the URL is one associated with the Transition Homepage and not the URL of the selected vendor's website. Such framing may incorporate known techniques such as containment of the vendor's website within a frame, iframe, or division-tag (DIV).

In one embodiment of the present invention, the homepage selection program 142 may first frame the selected vendor's website within the Transition Homepage for a period of time and then redirect the Transition Homepage to the URL of that vendor's website.

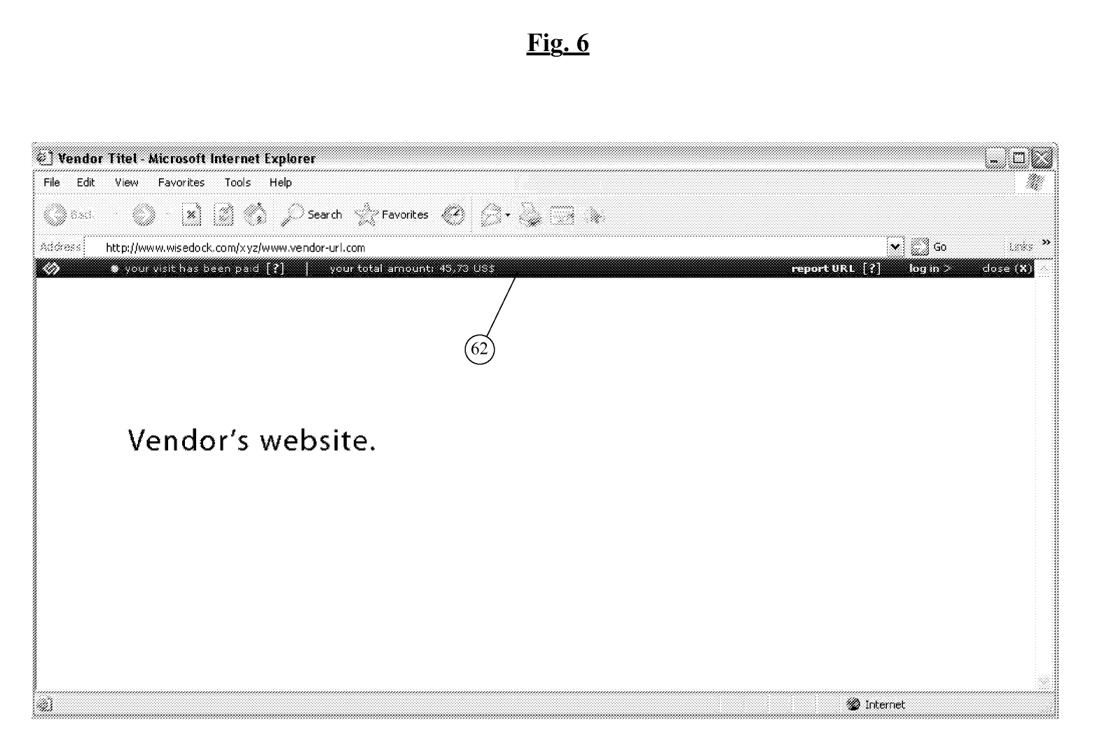

While the selected vendor's website is framed within the Transition Homepage, the homepage selection program 142 may generate and display a system information bar 62 in the client's browser, as shown in FIG. 6. The information bar 62 may provide confirmation to the client that he or she received the appropriate credit for that homepage launching of the vendor's website and may provide information relating to the balance of client's account. The information bar 62 may further include a link to a log-in page on the System Website which the client may access to obtain detailed information regarding his or her account, make any changes to his or her account, and/or provide any feedback to the system 100 administrator. The information bar 62 may be configured such that it may be manually closed by the client or automatically removed from display after a predetermined amount of time, such as five seconds (step 448). At that time, the homepage selection program 142 may redirect the Transition Homepage to the URL of the selected vendor's website. The homepage selection program 142 may also be configured so that the client can be paid for a vendor website homepage display only if the client stays on that vendor's website for a certain predetermined interval of time, such as ten seconds, before closing the browser or otherwise leaving that vendor's website (“Viewing Time Constraint”).

Referring again to step 406 in FIG. 4, if the homepage selection program 142 determines that it is not the client computer's 102 first browser launch within a predetermined time interval, the homepage selection program 142 begins the process of randomly selecting a vendor website (Random Option) by determining whether the client has exceeded any of the system's 100 optional internal constraints for preventing clients from abusing the income generation system, such as by utilizing software programs that automatically and frequently open browsers without user input. One example of an internal constraint is that the homepage selection program 142 may be configured so that a client can be paid for a vendor website launching only if a predetermined time period has lapsed since his or her last homepage launching or click on the “Home” button, such as ten minutes (“Elapsed Time Constraint”) (step 434). An additional example is that the homepage selection program 142 may be configured such that the client can only be paid for a certain number of vendor website homepage launchings within a predetermined time period, such as a day, even if the client does not exceed the Elapsed Time Constraint (“Maximum Launchings Constraint”) (step 436). The homepage selection program 142 may implement any one or combination of the Viewing Time, Elapsed Time, Maximum Launchings, or other constraints. Also, any of the time intervals associated with such constraints may be predetermined to be consistent time frames of random time frames.

If the client has exhausted the Elapsed Time or Maximum Launchings constraints, the homepage selection program 142 tags the client's homepage launching as a “No User Credit” launching (step 438) and continues selecting either the client's Alternate Homepage (steps 440, 432) or a randomly selected registered vendor's website (steps 414 et seq.) depending on how the client has setup his or her user preferences (see FIG. 2C). The client is not paid for any homepage launching tagged as a No User Credit launching and the information bar 62, such as the one depicted in FIG. 6, may indicate that the vendor website homepage launching was provided by the system 100 but that the launching is a No User Credit launching. The information bar 62 may also include a link on which the client can click to be transferred to the System Website to determine why that launching was tagged as a No User Credit launching.

If the client computer 102 has not exceeded any of the system's 100 internal constraints that limit payment for vendor website homepage launchings, such as the Elapsed Time and Maximum Launchings Constraints (steps 434, 436), the homepage selection program 142 may identify all active and approved Random Option vendor campaigns with corresponding campaign dates and language (step 414). Random Option advertisement campaigns are those in which when registered clients activate their respective homepages by launching their Internet browsers or clicking on the “Home” button, the system 100 will, unlike the Prime Option, randomly determine which vendor's website is displayed in each client's browser. Accordingly, the number of homepage launchings directed to a particular vendor's website may depend on how many other vendors are running campaigns targeting the same or overlapping client target groups (geography, age, topics of interest, etc.) at the same time.

The homepage selection program 142 then filters from the list of Random Option campaigns any campaigns whose web pages are associated with target consumer criteria that do not align with any aspect of the client's web page selection criteria by comparing each campaign's target consumer information (as indicated by the vendors in the setup of their respective campaigns) with the profile of the requesting client (step 416).

The homepage selection program 142 also reviews the URL history of the requesting client's browser to determine if the client has already viewed a particular vendor's website within a predetermined interval of time. The vendor websites which have already been launched as homepages by that client within the predetermined time are filtered from that client's homepage availability list (step 418) to aid in the client's view of different, randomly generated vendor websites as homepage launches. If there are no paying campaigns left in the list after the filtering process in steps 416 and 418 and the client's homepage launching was tagged as a No User Credit launching (in step 438), the homepage selection program 142 may select a non-self-registered vendor's website (i.e., a vendor that has not voluntarily registered with the system 100 or paid for an advertising campaign) from a system 100 created advertising campaign as the client's homepage launching, at no cost to that non-self-registered vendor (step 422). More specifically, a system administrator may create a “No Vendor Cost” campaign in the homepage selection program 142 just as a self-registered vendor would by, for example, inputting URLs for certain non-self-registered vendor websites and categorizing them based on likely target audience such as age, location, and topics of interest, etc. Because vendors do not pay for their websites to be part of a “No Vendor Cost” campaign, clients do not receive any revenue for homepage launchings of such websites. In many cases, a non-self-registered vendor may not even know that its website is part of a No Vendor Cost campaign but such non-self-registered vendor still benefits if its website is selected by the system 100 as a client homepage launching because of the increased website traffic.

The homepage selection program 142 next determines whether there are any exact matches between the available campaigns (Random Option or No Vendor Cost campaigns) and the target group of the requesting client (step 424). If there are no matches, the homepage selection program 142 selects the client's Alternate Homepage to display in the client computer's 102 browser (steps 426 and 432) or randomly selects the next best vendor campaign (step 428), depending on the client's account preferences (see FIG. 2C). Provided that there is an exact match between the requesting client's preferences and the available vendor campaigns (step 424), the homepage selection program 142 randomly selects one of the available vendor campaigns (step 430), processes the corresponding financial transactions as appropriate (step 442; see FIG. 5) and either automatically redirects client's browser from its Transition Homepage to that vendor's website or frames that vendor's website within the Transition Homepage in a seamless and quick manner (steps 444 and 446) as described above. In one embodiment, such random selection process may include the assignment of weighted values depending, for example, on how close a registered vendor is to maximizing its advertising campaign budget, as explained above.

Referring now to FIG. 5, which depicts the payment processing method (step 442 of FIG. 4) in more detail, the homepage selection program 142 ascertains whether the vendor website selected for the client's homepage launching is part of a Prime Option or Random Option campaign (in other words, a campaign paid for by the vendor), or a No Vendor Cost campaign (step 510). The system 100 may be configured such that each time the homepage selection program 142 selects a registered vendor's website for a homepage launching in the client computer's 102 browser, such registered vendor's pays to the system 100 a predetermined amount of money, such as twenty cents, which may be debited from the vendor's prepaid account (steps 512 and 514). As mentioned above, during setup of the campaign, the vendor may have the option of designating a maximum amount of funds that can be spent on advertising within a predetermined time interval, such as $100 per day.

If, at any time, the homepage selection program 142 determines a vendor does not have enough value associated with its account to proceed with the next advertisement campaign (step 516), the homepage selection program 142 may render all such vendor's campaigns as “inactive” (step 518). The inactive status means that the homepage selection program 142 will suspend directing the homepages of client computers 102 to that vendor's website(s). Similarly, if, at any time, the homepage selection program 142 determines that the vendor has already met its budget for a particular time interval within the duration of the campaign (step 520) (for example, the vendor's website has already been displayed as the homepage enough times on various client computers 102 to reach the daily budget), the homepage selection program 142 may render such vendor's campaign as inactive for that particular time interval until the time refreshes, such as rolls over into the next day or next week (step 522). Vendors may access the System Website at any time to change their campaign budgets and add additional funds to their account.

Still referring to FIG. 5, the homepage selector program 142 determines whether the client's bank account or other electronic funds transfer information has been identified from client's user profile (step 524) and, if so, determines whether the client's homepage launching of the selected vendor's website has been tagged as a No User Credit launching, as described above with respect to step 438 in FIG. 4 (step 526). For example, a client's next vendor website homepage launching could have been tagged as No User Credit because he or she has exceeded maximum number of paid vendor website homepage launchings within a predetermined time interval.

If the homepage selection program 142 is able to identify account information for the client (step 524) and the next client's browser launch has not been tagged as a No User Credit launching (step 526), the homepage selection program 142 determines the appropriate payment due to client for viewing the selected vendor's website (step 528) as client's homepage and credits the client's account for the same (step 530). For example, the homepage selection program 142 may credit to the client's virtual account within the System Website a predetermined amount of currency or credits for each credit-rendering launch of a vendor's website as client's homepage, such as five cents per homepage launch. Once the client's account reaches a predetermined value or at a predetermined time interval, the homepage selection program 142 may direct the account value to be disbursed to the client via electronic transfer to the client's bank account, PayPal® account or the like. The homepage selection program 142 may also provide the client with the option of choosing when to have his or her account balance disbursed or “rolled over” for the next period of time.

In an additional feature of the present invention, the homepage selection program 142 may determine, based on client account information, whether the particular client being paid for a vendor website homepage launching was referred to the system 100 by another client (step 532). If so, the homepage selection program 142 may implement a referral incentive and award the referring client with a certain percentage of the value credited to the viewing client (step 534). The referral fee paid to the referring client may be credited to that client's account or disbursed in the same manner as described herein for client payment (step 536).

The system 100 may be configured such that whenever the homepage selection program 142 directs a client computer's 102 browser to a registered vendor's website as the client's homepage launching (i.e., a vendor that has paid for a Prime Option or Random

Option campaign), the homepage selection program 142 allocates to charitable causes a percentage of the system's 100 advertising transaction revenue from providing that vendor's website as the client computer's homepage launching (step 538). The homepage selection program's 142 determination of how much and when to credit its charitable donations account may be based on preferences set up in the homepage selection program 142 server by the system 100 administrator. For example, the system 100 administrator may set the preferences within the homepage selection program 142 to allocate credits from display of certain types of registered vendor websites to particular charities. The homepage selection program 142 may also enable each client to allocate his or her revenue generated from vendor website homepage launchings to charitable causes selected by the client.

In summary, the above-described system 100 and method for providing a web browser homepage as a means for increasing targeted vendor website traffic and generating client income provides clients with an interesting way to view a new website at each launch of its browser or return to the “Home” page. In many cases, the client will view a homepage that is related to the client's fields of interest and the client will have the pleasure of earning revenue while viewing the interesting websites.

The above-described system 100 and method also provides an advantage to vendors of having their websites automatically displayed in client browsers, rather than having to pay a third party publisher to provide a link or banner for which the client has to click through to reach to vendor's website. Additionally, the vendor is able to engage in more targeted advertising by creating campaigns where its website is more likely to be viewed by consumers in the desired demographic.

Because the system 100 and method of the present invention do not utilize a third party website to provide links or banners for which clients must click through to reach to vendor websites, the vendors receive more value from the cost of advertising with the present system 100 and the vendor is able to display its actual website to the client instead of just a small advertisement. Finally, the system 100 and method of the present invention is mutually beneficial to both vendors and clients.

While several embodiments have been described in detail herein, it will be apparent to those skilled in the art that the disclosed embodiments may be modified. Therefore, the foregoing description is to be considered exemplary and is not intended to limit the invention to these embodiments. On the contrary, the invention is intended to cover alternatives, modifications and equivalents, which may be included within the spirit and scope of the invention as defined by the appended claims.

Furthermore, in the detailed description of the present invention, numerous specific details are set forth in order to provide a thorough understanding of the present invention. In other instances, well-known methods, procedures, components, and circuits have not been described in detail as not to unnecessarily obscure aspects of the present invention. However, it will be recognized by one of ordinary skill in the art that the present invention may be practiced without these specific details.

What is claimed is:

1. A method of causing a website to be displayed as the homepage for at least one computer's web browser comprising the steps of:
identifying at least one computer having a web browser in which a homepage URL (“Transition URL”) has been designated for the web browser;
selecting a web page having a URL that is differs from the Transition URL to be displayed as the web browser's homepage (“Selected Web Page”);
communicating instructions capable of causing the Selected Web Page to be displayed in the web browser of the computer when a homepage activator associated with the web browser is activated; and
determining whether to charge an operator of the Selected Web Page a fee for communicating the instructions capable of causing the Selected Web Page to be displayed as the web browser's homepage.

2. The method of claim 1 further comprising the step of determining whether to grant a user associated with the computer a reward for the display of the Selected Web Page as the web browser's homepage.

3. The method of claim 1 wherein the homepage activator is activated by an action selected from the group consisting of engagement of a homepage button in the web browser and opening of the web browser.

4. The method of claim 1 wherein, the instructions are capable of causing the Selected Web Page to be the first web page displayed in the web browser when the web browser's homepage activator is activated, without requiring any further activation or action by the user.

5. The method of claim 1 wherein the identifying step comprises the step of identifying the computer based on indicia selected from the group consisting of the Transition URL and a web browser cookie.

6. The method of claim 1 wherein the selecting step comprises the step of analyzing web page selection criteria that is communicated from a user associated with the computer, wherein the web page selection criteria is selected from the group consisting of the user's age, sex, geographic location, language, income level, career, and topics of interest.

7. The method of claim 6 wherein the selecting step further comprises the step of analyzing target consumer criteria for a plurality of web pages, wherein the target consumer criteria is selected from the group consisting of target consumer age, sex, geographic location, language, income level, career, and topics of interest.

8. The method of claim 7 wherein the target consumer criteria for each web page in the plurality of web pages is communicated from at least one person that has reviewed the content of the web page.

9. The method of claim 2 further comprising the step of determining whether the web browser's homepage activator has been activated for the first time within a predetermined time interval.

10. The method of claim 9 wherein the selecting step comprises the step of determining whether any web page operator has chosen to have its web page be the Selected Web Page the first time the web browser's homepage activator is activated within the first predetermined time interval.

11. The method of claim 10 wherein the selecting step further comprises the step of selecting a particular web page to be the Selected Web Page if it is determined that the web browser's homepage activator has been activated for the first time within the first predetermined time interval and the operator of that particular web page has chosen to have its web page be the Selected Web Page the first time the web browser's homepage activator is activated within the first predetermined time interval.

12. The method of claim 2 wherein the step of determining whether to grant the user associated with the computer a reward for the display of the Selected Web Page comprises the steps of:
determining whether a second predetermined time interval has lapsed between consecutive activations of the web browser's homepage activator; and
if the second predetermined time interval has not lapsed, determining that no reward will be granted to the user for the display of the Selected Web Page in the web browser of the computer.

13. The method of claim 2 wherein the step of determining whether to grant the user associated with the computer a reward for the display of the Selected Web Page comprises the steps of:
determining whether a third predetermined time interval has lapsed between communicating the instructions capable of causing the Selected Web Page to be displayed in the web browser of the computer and the user's initiation of a web page termination event, the web page termination event being selected from the group consisting of a user's closing the Selected Web Page, leaving of the Selected Web Page to go to a different web page, closing of the web browser, and reactivation of the home page activator; and
if the third predetermined time period has not lapsed, determining that no reward will be granted to the user for the display of the Selected Web Page in the web browser of the computer.

14. The method of claim 9 wherein the step of determining whether to grant the user associated with the computer a reward for the display of the Selected Web Page comprises the steps of:
determining whether the web browser's homepage activator has been activated more than a predetermined number of times within the first predetermined time interval; and
if the web browser's homepage activator has been activated more than a predetermined number of times within the first predetermined time interval, determining that the no reward will be granted to the user for display of the Selected Web Page in the web browser of the computer.

15. The method of claim 2 further comprising the step of granting a reward to the user associated with the computer for the display of the Selected Web Page in the web browser of the computer.

16. The method of claim 15 wherein the reward has a value selected from the group consisting of a monetary value and a credit value.

17. The method of claim 2 further comprising the step of randomly selecting the Selected Web Page from a plurality of web pages if it is determined that the user associated with the computer will not be rewarded for display of the Selected Web Page in the web browser.

18. The method of claim 2 further comprising the step of selecting a predetermined web page chosen by the user as the Selected Web Page if it is determined that the user associated with the computer will not be rewarded for display of the Selected Web Page in the web browser of the computer.

19. The method of claim 7 wherein the selecting step further comprises the steps of:
comparing the user's web page selection criteria with the target consumer criteria for the plurality of web pages; and
filtering from a set of the plurality of web pages any web pages with target consumer criteria that do not align with any aspect of the user's web page selection criteria.

20. The method of claim 19 wherein the selecting step further comprises the step of filtering from the set of the plurality of web pages any web pages that have already been displayed in the computer's web browser within a predetermined time interval.

21. The method of claim 19 wherein the selecting step further comprises the step of randomly selecting the Selected Web Page from the plurality of web pages remaining in the set after the filtering step.

22. The method of claim 19 wherein the selecting step further comprises the step of selecting a predetermined web page chosen by the user as the Selected Web Page if it is determined that there are no web pages remaining in the set after the filtering step.

23. The method of claim 1 further comprising the step of charging the operator of the Selected Web Page a fee for communicating the instructions capable of causing the Selected Web Page to be displayed as the homepage of the web browser.

24. The method of claim 23 further comprising the step of deducting from a prepaid account the fee charged to the operator of the Selected Web Page.

25. The method of claim 1 further comprising the step of enabling an operator of a web page to establish an advertising budget that limits an amount of fees that may be charged to the operator for its web page being selected as the Selected Web Page.

26. The method of claim 25 further comprising the steps of:
determining whether the advertising budget associated with a web page has been met or exceeded; and
if the advertising budget has been met or exceeded, preventing that web page from being the Selected Web Page.

27. The method of claim 2 further comprising the step of communicating instructions capable of causing the display of an information bar in the web browser of the computer when the Selected Web Page is displayed in the web browser, wherein the information bar provides information selected from the group consisting of a hyperlink to a system website, the user's account balance, and information regarding whether the user was designated to receive the reward for display of the Selected Web Page.

28. The method of claim 2 further comprising the step of granting a second user of a second computer a referral reward for the first user displaying the Selected Web Page in the web browser of the first computer.

29. The method of claim 1 further comprising the step of granting to charitable cause a portion of any fee charged to the operator of the Selected Web Page for the display of the Selected Web Page in the web browser of the computer.

30. The method of claim 1 wherein the computer is a digital computing device selected from the group consisting of a personal computer, personal digital assistant (PDA), or mobile phone.

31. The method of claim 1 wherein the step of communicating instructions capable of causing the Selected Web Page to be displayed in the web browser comprises the step of redirecting the Transition URL to the URL of the Selected Web Page when the homepage activator associated with the web browser is activated.

32. The method of claim 1 wherein the step of communicating instructions capable of causing the Selected Web Page to be displayed in the web browser comprises the step of framing the Selected Web Page in a web page associated with the Transition URL when the homepage activator associated with the web browser is activated.

33. The method of claim 1 wherein the framing step comprises the step of framing the Selected Web Page using a framing technique selected from the group consisting of a frame, iframe, and division-tag (DIV).

34. A method of causing a website to be displayed as the homepage for at least one computer's web browser comprising the steps of:
identifying at least one computer having a web browser in which a homepage URL (“Transition URL”) has been designated for the web browser;
selecting a web page having a URL that is differs from the Transition URL to be displayed as the web browser's homepage (“Selected Web Page”); and
communicating instructions capable of causing the Selected Web Page to be displayed in the web browser of the computer;
wherein selecting step comprises the steps of:
analyzing web page selection criteria input by a user associated with the computer, the web page selection criteria being selected from the group consisting of the user's age, sex, geographic location, language, income level, career, and topics of interest; and
analyzing target consumer criteria for a plurality of web pages, wherein the target consumer criteria is selected from the group consisting of target consumer age, sex, geographic location, language, income level, career, and topics of interest; and
wherein when the web browser's homepage activator is activated, the first web page displayed in the web browser is the Selected Web Page without requiring any further activation or action by the user.

35. A computer system comprising:
one or more processors;
one or more memory units storing instructions operable with the one or more processors, the instructions being executed for:
identifying at least one computer having a web browser in which a homepage URL (“Transition URL”) has been designated for the web browser;
selecting a web page having a URL that differs from the Transition URL to be displayed as the web browser's homepage (“Selected Web Page”); and
communicating instructions capable of causing the Selected Web Page to be displayed in the web browser of the computer; and
wherein selecting step comprises the steps of:
analyzing web page selection criteria input by the user associated with the computer, the web page selection criteria being selected from the group consisting of the user's age, sex, geographic location, language, income level, career, and topics of interest; and
analyzing target consumer criteria for a plurality of web pages, wherein the target consumer criteria is selected from the group consisting of target consumer age, sex, geographic location, language, income level, career, and topics of interest; and
wherein when the web browser's homepage activator is activated, the first web page displayed in the web browser is the Selected Web Page without requiring any further activation or action by the user.

36. A computer system comprising:
one or more processors;
one or more memory units storing instructions operable with the one or more processors, the instructions being executed for:
identifying at least one computer having a web browser in which a homepage URL (“Transition URL”) has been designated for the web browser;
selecting a web page having a URL that differs from the Transition URL to be displayed as the web browser's homepage (“Selected Web Page”);
communicating instructions capable of causing the Selected Web Page to be displayed in the web browser of the computer;
determining whether to charge an operator of the Selected Web Page a fee for communicating the instructions capable of causing the Selected Web Page to be displayed as the web browser's homepage; and
determining whether to grant a user associated with the computer a reward for the display of the Selected Web Page as the web browser's homepage.
